(19) United States
(12) Patent Application Publication
(10) Pub. No.: US 2015/0016706 A1
(43) Pub. Date: Jan. 15, 2015

(54) BANKNOTE COUNTING AND AUTHENTICATING MACHINE AND METHOD THEREOF

(71) Applicant: Climax Machine Industry Co., Ltd., New Taipei City (TW)

(72) Inventors: Tien-Lu HSU, New Taipei City (TW); Rong-Chin LO, New Taipei City (TW); Chien-Hung CHEN, New Taipei City (TW); Chi-Chan LEE, New Taipei City (TW); Wei-Chih CHEN, New Taipei City (TW); Shin-Nung LU, New Taipei City (TW); Chia-Wei WU, New Taipei City (TW)

(73) Assignee: CLIMAX MACHINE INDUSTRY CO., LTD., New Taipei City (TW)

(21) Appl. No.: 14/325,888

(22) Filed: Jul. 8, 2014

(30) Foreign Application Priority Data
Jul. 9, 2013 (TW) 102124561

(51) Int. Cl. G07D 7/20

(52) U.S. Cl. CPC G07D 7/2025
USPC 382/135

(57) ABSTRACT

A machine includes an electronic control module for conducting authentication process of a banknote and transiting/receiving every module signal to control operation of a user interface; an image control module for activating an image sensor to read and authenticate the banknote upon receipt of a banknote input signal from the electronic control module, thereby resulting in an authenticated result and transmitting back to the electronic control module; a motor control module for causing a corresponding motor operation of a motor upon receipt of a command signal from the electronic control module; and a counterfeit control module for processing a banknote data via a reading head, a thickness detector and an infrared scanner upon receipt of another signal from the electronic control module and generating, transmitting a banknote result back to the electronic control module for further processing.

### CROSS-REFERENCES TO RELATED APPLICATIONS

This application claims the priority of Taiwanese patent application No. 102124561, filed on Jul. 9, 2013, which is incorporated herewith by reference.

### BACKGROUND OF THE INVENTION

1. Field of the Invention

The present invention relates to a banknote counting machine and method thereof, more particularly to a banknote counting and authenticating machine and method thereof.

2. The Prior Arts

Counting banknotes is a general practice for bankers and majority of businessman. Hence a banknote counter is an indispensable tool for each desk counter in a bank and is a usual view for those visiting a bank while drawing or disposing the banknotes. For bankers, the banknote counter should provide high efficient counting function in addition to the authentication function for checking the forged banknote.

Several banknote counting machines have been developed since they are highly needed in the banking business or trading, many new types are available in the market and majority of the machines are provided with banknote authentication function for finding out the forged banknote. In addition to the authentication function, the counting speed is also a must for the inventor to take account of while designing the banknote counting machine.

### SUMMARY OF THE INVENTION

Therefore, the objective of the present invention is to provide a banknote counting machine that has high speed counting ability and the method thereof.

Another objective of the present invention is to provide a banknote counting machine that has banknote authentication function in addition to the high speed counting ability and the method thereof so that forged banknote can be located.

In order to eliminate the prior art drawback, a banknote counting machine is provided according to the present invention. The machine accordingly includes an electronic control module for conducting authentication process of the banknote and transiting/receiving every module signal to control operation of a user interface; an image control module for activating an image sensor to read and authenticate the banknote upon receipt of a banknote input signal from the electronic control module, thereby resulting in an authenticated result and transmitting back to the electronic control module; a motor control module for causing a corresponding motor operation of a motor upon receipt of a command signal from the electronic control module; and a counterfeit control module for processing a banknote data via a reading head, a thickness detector and an infrared scanner upon receipt of another signal from the electronic control module and generating, transmitting a banknote result back to the electronic control module for further processing.

In one embodiment of the present invention, the electronic control module further includes an initialization unit for initializing operation systems, execution programs, communication programs of hardware and software in each of the modules when switch-on action of the machine and displaying the operation systems and the execution programs in ready position or a malfunction signal upon finishing initialization of each of the modules; a counterfeit unit for authenticating the banknote including detecting and processing the banknote, thereby resulting in the banknote result; a signal transmission unit for transmitting and receiving signal among the modules; and a user interface unit for displaying the banknote result which is generated from the counterfeit unit and which is shown on a display panel.

In one embodiment of the present invention, the image control module further includes: an image fetching unit for activating the image sensor (such as contact image sensor) upon receipt of the banknote input signal so as to scan the banknote via a built-in Complex Programmable Logic Device (CPLD), thereby generating an image data and converting the image data into a two dimensional signal; and an image verifying unit for receiving the image data from the image fetching unit via Programmable Peripheral Interface (PPI) and conducting the authentication process of the banknote via Direct Memory Access (DMA) when the image data reaches a first default value.

Preferably, the first default value is defined initially by a digital signal processor.

In one embodiment of the present invention, the authentication process of the banknote preferably includes: checking position of the banknote: checking if corners of the banknote are folded; checking direction of the banknote; checking total amount of the banknote, checking if the banknote is stained; and transmitting the authenticated result back to the electronic control module.

The authentication process of the banknote preferably includes: enabling the PPI in order to receive the image data from the image fetching unit; and interrupting the DMA in order to stop conducting the authentication process of the banknote.

In one embodiment of the present invention, the corresponding motor operation caused by the motor control module includes: activating the motor; de-activating the motor; stopping the motor in emergency situation; returning the motor to its initial speed; and resume the motor to run in an idling state.

In one embodiment of the present invention, the counterfeit module includes an execution program, upon power supplied to the machine owing to switch-on action of the machine, for conducting an execution operation including initialization of basic settings, self checking, checking communication among modules, idling or suspending signal and abnormal signal; a communication unit establishing and checking communication between the counterfeit control module and an external component via the user interface, and turning into an idle mode after completion of the execution operation; an external execution program adapted to be coupled with a PC in order to use execution program of the PC, thereby simultaneously updating the external execution program to fetch and/or store data in the PC and realizing the authentication process of the banknote; and a counterfeit execution program, upon receipt of the banknote input signal, for conducting the authentication process of the banknote and transmitting the banknote result back to the electronic control module via the communication unit.

Preferably, the authentication process of the banknote further includes a thickness detection program, a magnet detection program and an infrared detection program.

In one embodiment of the present invention, the thickness detection program is capable of activating a thickness detector so as to determine if thickness of the banknote is normal or not.

In one embodiment of the present invention, the magnet detection program is capable of activating the reading head so as to fetch a magnetic signal from the banknote to determine the total amount of the banknote and detect if the banknote is forged.

In one embodiment of the present invention, the infrared detection program is capable of activating an infrared scanner so as to scan colors of the banknote via infrared rays in order to differentiate value amount of the banknotes based on the scanned colors.

The method of the present invention for counting and authenticating a banknote includes the steps of: activating an electronic control module for controlling a banknote counting and authenticating and transiting/receiving every module signal to control operation of a user interface of a machine; receiving a banknote input signal from the electronic control module to activate an image sensor to read and authenticate the banknote, thereby resulting in an authenticated result and transmitting back to the electronic control module; causing a corresponding motor operation of a motor in the machine upon receipt of a command signal from the electronic control module; and activating a banknote authentication process of the banknote via a reading head, a thickness detector and an infrared scanner in the machine upon receipt of another command signal from the electronic control module and generating, transmitting a banknote result to the electronic control module for further processing.

In one embodiment of the method of the present invention, the authentication process further includes the steps of: waiting till finishing of disposal of the banknote in a banknote reception slot and checking position of the banknote in the banknote reception slot prior to counting operation begin; start counting the banknote and transmitting an inform signal to a motor control module to simultaneously activate timer Interrupt Service routine (ISR); the image sensor scanning the banknote at each interruption interval caused by timer ISR so as to check position of the banknote, thereby recording banknote position data; based on the banknote position data, a communication signal to be sent being stored in a communication unit and transmitting an interruption signal to interrupt counting of the banknote; based on the banknote position data, activating a banknote counter in the machine for counting the banknote; a signal transmission unit checking if the communication signal performs corresponding function based on the banknote signal; deciding, based on the banknote position data and depending on an executed result generated from the banknote counter, whether to reject the banknote or not; determining sheet amount of the banknote and if the banknote is spilled over the banknote reception slot; and storing a display result within the user interface to be displayed over a display screen.

The above-mentioned transiting/receiving every module signal step includes: checking if a signal being stored within a cache; if yes, transferring the signal from the cache to a corresponding buffer for automatically transmitting the signal; returning to a suspending mode for waiting a response due to transmission of the signal, turning to a next step if the transmission of the signal incorrect, delete the signal from the buffer if the transmission of the signal is correct and transmitting a software interruption signal and deleting a response flag; and entering into a retransmission mode for checking an output hardware function normally or not and retransmitting the software interruption signal again.

In one embodiment of the method of the present invention, the control operation of the user interface includes the steps: (a) checking if a signal being stored within a cache; (b) if yes, inputting pattern number corresponding to array position of code mark representing the signal; (c) transmitting a pattern and position data to be displayed to a display panel; (d) generating a hardware interruption signal upon touching the display panel of display device and transmitting a coordinate of the touching signal; (e) neglecting the coordinate of the touching signal in case of counting condition, and generating a function pointer corresponding to the coordinate of the touching signal in case of non-counting condition; and (f) performing an execution (a task) corresponding to the function pointer and transmitting a software interruption signal upon completion of the task to repeat steps (a)-(c) or else finishing.

In one embodiment of the method of the present invention, the image fetching process further includes the steps: activating the image sensor (such as contact image sensor) upon receipt of the banknote input signal so as to scan the banknote via a built-in CPLD, thereby generating an image data and converting the image data into a two dimensional signal; and receiving the image data via PPI and conducting the authentication process of the banknote via DMA when the image data reaches a first default value.

In one embodiment of the method of the present invention, the authentication process of the banknote preferably includes: checking position of the banknote: checking if corners of the banknote are folded; checking direction of the banknote; checking total amount of the banknote; checking if the banknote is stained; and transmitting the authenticated result back to the electronic control module.

In one embodiment of the method of the present invention, the authentication process of the banknote preferably includes the steps: enabling the PPI in order to receive the image data from the image fetching unit; and interrupting the DMA in order to stop conducting the authentication process of the banknote.

In one embodiment of the present invention, the corresponding motor operation of the motor during the authentication process of the banknote preferably includes the steps: activating the motor; de-activating the motor; stopping the motor in emergency situation; returning the motor to its initial speed; and resume the motor to run in an idling state.

In one embodiment of the method of the present invention, the counterfeit execution program mainly includes a thickness detection program, a magnet detection program and an infrared detection program, wherein upon receipt of the banknote input signal from the electronic control module, conducts the banknote authentication process and transmits the authentication report back to the electronic control module.

In one embodiment of the method of the present invention, the thickness detection program is capable of activating a thickness detector so as to determine if thickness of the banknote is normal or not. Note that prior to determining the thickness of the banknote, the thickness detection program is also capable of delaying fetching of data; activating the thickness detector only upon receipt of the banknote input signal from the electronic control module 10 so as to fetch data; fetching thickness data of the banknote and storing the thickness data within a cache; scanning the thickness of the banknote upon the thickness data reaching a first default value and determining the thickness of the banknote is normal or not; de-activating the thickness detector when the thickness data reaching a second default value; balancing left and right of the thickness detector and providing compensation temperature to the thickness detector; checking if corners of the banknote are folded; and transmitting a thickness result of the banknote back to the electronic control module 10.

In one embodiment of the method of the present invention, the magnet detection program is capable of activating a reading head so as to fetch a magnetic signal from the banknote to determine the total amount of the banknote and detect if the banknote is forged. Note that prior to determining the total amount of the banknote, the magnet detection program is capable of delaying fetching of data; activating the reading head only upon receipt of the banknote input signal from the electronic control module so as to fetch data; fetching magnetic data of the banknote and storing the magnetic data within a cache; authenticating the banknote quickly upon the magnetic data reaching a first default value to check if the banknote has magnetic reflection; de-activating the reading head when the magnetic data reaches a second default value to check if the banknote has magnetic reflection; checking if banknote surface of the banknote has magnetic response and analyzing whether magnetic regions and total amount of the banknote are compatible with those stored within a data base; and transmitting a magnetic result of the banknote back to the electronic control module.

In one embodiment of the method of the present invention, the infrared detection program is capable of activating an infrared scanner so as to scan colors of the banknote via infrared rays in order to differentiate value amount of the banknotes based on the scanned colors. Note that prior to determining the total amount of the banknote, the infrared detection program is capable of delaying fetching of data; activating the infrared scanner only upon receipt of the banknote input signal from the electronic control module so as to fetch data; fetching data of the banknote via infrared rays and storing the data within a cache.

The infrared scanning process further includes: authenticating the banknote quickly upon the data reaching a first default value so as to check colors of the banknote; de-activating the infrared scanner when the data reaches a second default value; correcting and providing compensation data to the infrared scanner; checking if colors of the banknote are compatible with those stored within a data base; and transmitting an infrared result back to the electronic control module.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a block diagram representing elements constituting a banknote counting and authenticating machine of the present invention;

FIG. 2 shows a block diagram representing an electronic control module employed in the banknote counting and authenticating machine of the present invention;

FIG. 3 shows a block diagram representing an image control module employed in the banknote counting and authenticating machine of the present invention;

FIG. 4 shows a block diagram representing a counterfeit control module employed in the banknote counting and authenticating machine of the present invention;

FIG. 5 illustrates steps constituting a method for counting and authenticating a banknote according to the present invention;

FIG. 6 illustrates steps of conducting authentication process of the banknote according to the present invention;

FIG. 7 illustrates steps of transmitting/receiving a module signal among modules employed in the banknote counting and authenticating machine of the present invention;

FIG. 8 illustrates steps of controlling operation a user interface employed in the banknote counting and authenticating machine of the present invention;

FIG. 9 illustrates steps of banknote authentication process of the present invention;

FIG. 10 illustrates some steps for detecting thickness of the banknote via a thickness detection program in the present invention;

FIG. 11 illustrates some steps for determining total amount of the banknote via magnet detection program in the present invention; and

FIG. 12 illustrates some steps for authenticating images in the banknote via an infrared detection program in the present invention.

### DETAILED DESCRIPTION OF THE PREFERRED EMBODIMENT

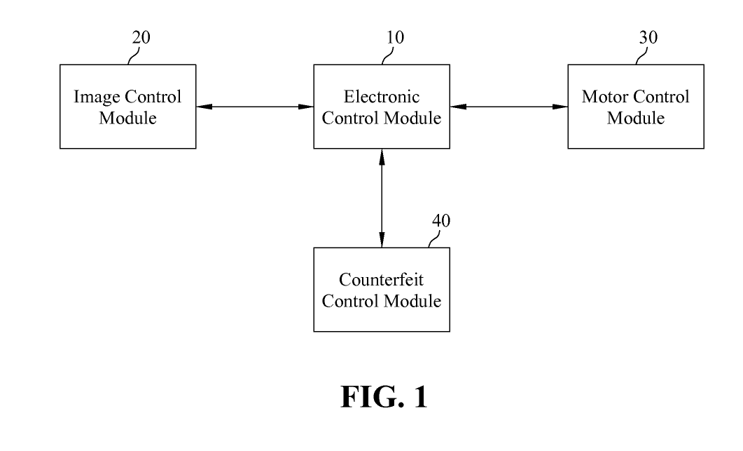

Referring to FIG. 1, wherein FIG. 1 shows a block diagram representing elements constituting a banknote counting and authenticating machine of the of the present invention. The machine of the of the present invention includes an electronic control module 10 for conducting authentication process of the banknote and transiting/receiving every module signal to control operation of a user interface; an image control module 20 for activating an image sensor to read and authenticate the banknote upon receipt of a banknote input signal from the electronic control module 10, thereby resulting in an authenticated result and transmitting the same back to the electronic control module 10; a motor control module 30 for causing a corresponding motor operation of a motor upon receipt of a signal from the electronic control module 10; and a counterfeit control module 40 for processing a banknote data via a reading head, a thickness detector and an infrared scanner upon receipt of another signal from the electronic control module 10 and generating, transmitting a banknote result back to the electronic control module 10 for further processing.

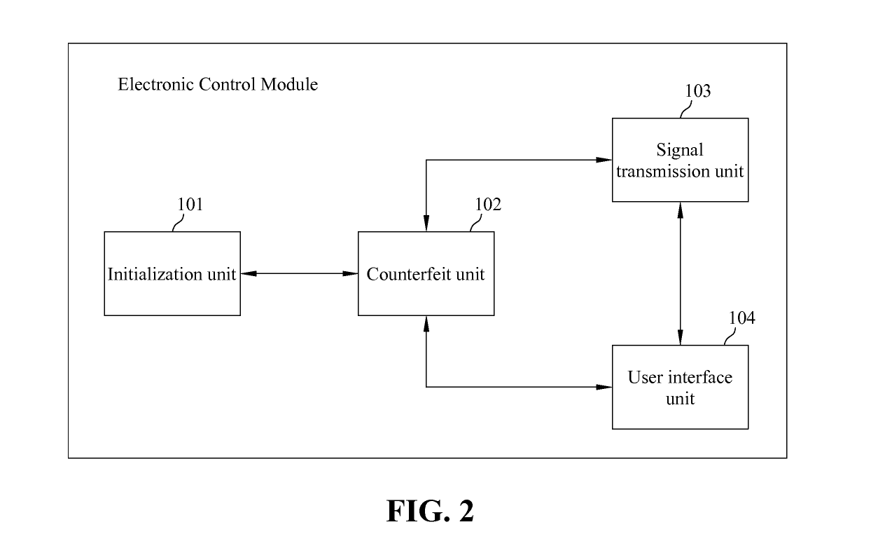

The operation and execution process among the above mentioned modules will be explained in the following paragraphs. FIG. 2 shows a block diagram representing the electronic control module 10 employed in the banknote counting and authenticating machine of the present invention. As illustrated, the electronic control module 10 further includes an initialization unit 101 for initializing operation systems, execution programs, communication programs of hardware and software in each of the modules when switch-on action of the machine and displaying the operation systems and the execution programs in ready position or a malfunction signal upon finishing initialization of each of the modules; a counterfeit unit 102 for authenticating the banknote including detecting and processing the banknote, thereby resulting in the banknote result; a signal transmission unit 103 for transmitting and receiving signal among the modules; and a user interface unit 104 for displaying the banknote result which is generated from the counterfeit unit 102 and which is shown on a display panel (such as touch panel).

The initializing process conducted by the initialization unit 101 includes: setting up basic parameters the hardware for operation of detection devices, like speed rate of Serial Peripheral Interface (SPI), setting position of input and output (I/O) pins, initialization of the software for reading/erasing EEPROM read only like counting of banknotes, authenticating the banknote to find out forged banknote, establishing communication among the modules for transmission of signals, entering into the corresponding execution for each module after receiving a corresponding module signal or else display a malfunction signal.

The counterfeit unit 102, during the authentication process of the banknote, is adapted to conduct several actions including waiting till finishing of disposal of the banknote in a banknote reception slot and checking position of the banknote in the banknote reception slot prior to counting operation begin; start counting the banknote and transmitting an inform signal to the motor control module to simultaneously activate timer Interrupt Service routine (ISR); the image sensor scanning the banknote at each interruption interval caused by timer ISR so as to check position of the banknote, thereby recording banknote position data. While the banknote is being counted, the motor control module 30 conducts a corresponding motor operation including: (1) upon entering into a counting mode from the suspending mode, activating the motor employed in the present machine via General-Purpose Input/Output (GPIO); (2) transmitting a signal so as to deactivate and stop the motor in emergency situation; (3) returning the motor to its initial speed after the emergency situation via the GPIO; (4) resuming the motor to run in an idling state or stopping the same in case of the suspending mode; and (5) no signal is transmitted when no malfunction is shown. After counting of the banknote, the authentication process further includes checking position of the banknote at every interrupted interval caused by timer ISR and recording the banknote position data; checking based on the banknote position data if a communication signal to be sent being stored in a communication unit and transmitting an interruption signal to interrupt counting of the banknote; based on the banknote position data, activating a banknote counter in the machine for counting the banknote; checking by the signal transmission unit if the communication signal performs corresponding function based on the banknote signal; deciding, based on the banknote position data and depending on an executed result generated from the banknote counter, whether to reject the banknote or not; determining sheet amount of the banknote and if the banknote is spilled over the banknote reception slot; and storing a display result within the user interface to be displayed over a display screen.

The signal transmission unit 103 checks (the transmitting/receiving every module signal), upon receipt of a software interruption signal, if a signal to be sent being stored in a cache; if yes, transferring the signal from the cache to a corresponding buffer for automatically transmitting the signal via Universal Asynchronous Receiver/Transmitter (UART) of the image control module 20 and the SPI of the counterfeit control module 40; retuning to the suspending mode for waiting a response due to transmission of the signal, and turning to a next step if the transmission of the signal is incorrect, deleting the signal from the buffer if the transmission of the signal is correct and transmitting the software interruption signal and deleting a response flag; and entering into a retransmission mode for checking an output hardware function normally or not and retransmitting the software interruption signal again.

The signal transmission unit 103 can simultaneously receive a hardware interruption signal. In other words, upon receipt of the hardware interruption signal, the transmission unit 103 checks each of the above steps.

The user interface unit 104 performs a control operation of the user interface includes: checking if a signal being stored in a cache; if yes, inputting pattern number corresponding to array position of code mark representing the signal; transmitting a pattern and position data to be displayed to a display panel; generating a hardware interruption signal upon touching the display panel of display device and transmitting a coordinate of the touching signal; neglecting the coordinate of the touching signal in case of banknote counting condition, and generating a function pointer corresponding to the coordinate of the touching signal in case of non-counting condition; and performing a task corresponding to the function pointer and transmitting a software interruption signal upon completion of the task to repeat steps above steps or else terminating the user interface.

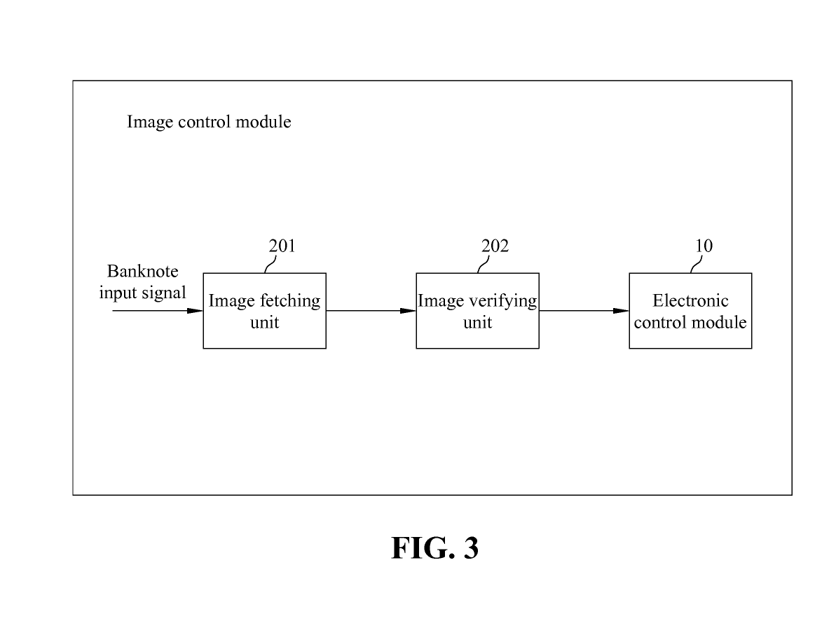

FIG. 3 shows a block diagram representing the image control module 20 employed in the banknote counting and authenticating machine of the present invention. As shown, the image control module 20 further includes: an image fetching unit 201 for activating the image sensor (such as contact image sensor) upon receipt of the banknote input signal so as to scan the banknote via a built-in CPLD, thereby generating an image data and converting the image data into a two dimensional signal; and an image verifying unit 202 for receiving the image data from the image fetching unit 201 via PPI and conducting the authentication process of the banknote via DMA on-off when the image data reaches a default value.

Prior to conducting the authentication process of the banknote, a digital signal processor (such as BF533) is used initially for defining the default value, connecting the PPI and DMA in series, presetting no of pieces as 2304×520. In other words, upon receiving data consisting 2304 pixels×520 lines in DMA via the PPI and CPLD results in an interruption of communication between the PPI and the DMA. Hence, the authentication process of the banknote is activated.

The above-mentioned authentication process includes: determining or checking image position of the banknote; checking if corners of the banknote are folded; checking direction of the banknote; checking total amount of the banknote, checking if the banknote is stained; and transmitting the authenticated result back to the electronic control module 10. The authentication process of the banknote further includes enabling the PPI and interrupting the DMA.

In checking position of the banknote, two pixel filters (5×2) (2×5) are used to locate the periphery of the banknote in the horizontal direction and in the vertical direction since one side of the banknote requires at least two points. Eight points are thus obtained via the filters to form a first image section, hence defining two left peripheral point, a second image section having four upper and lower peripheral points. A third image section with two right peripheral points is defined by eight peripheral points, hence obtaining four tips of the banknote. If no checking image position of the banknote is conducted, Recommend Standard-232 (RS-232) is used to inform “no authentication” to the electronic control module 10. In checking if corners of the banknote includes two dimensional imaging process is conducted for determination, if corners of the banknote are folded and RS-232 is used to inform “folded signal” to the electronic control module 10, the communication between the PPI and DMA is interrupted and is again enabled to perform the other authentication action. Checking direction of the banknote includes fetching image at left/right top and bottom corners, at ¼ or 9/10 of the banknote by applying characteristic to define the direction (upper/upper upper/lower direction) and the result is transmitted to the electronic control module 10 via the RS-232. Checking total amount of the banknote includes top point parameters and the length and width of the banknote are used to determine the total amount (100$, 200$, . . . , 200$), and the amount result is transmitted to the electronic control module 10 via the RS-232. Checking if the banknote is stained includes utilizing average value of image is used to determine whether the banknote is stained or not and the result is transmitted back to the electronic control module 10 via the RS-232.

The corresponding motor operation of the motor includes executing the interruption program and changing operation mode of the motor via the GPIO upon receipt of a signal from the electronic control module 10. The execution of the motor includes activating the motor; deactivating and stopping the motor in emergency situation; returning the motor to its initial speed after the emergency situation; resuming the motor to run in an idling state or stopping the same in case of the suspending mode; and transmitting the status quo of the motor to the electronic control module 10.

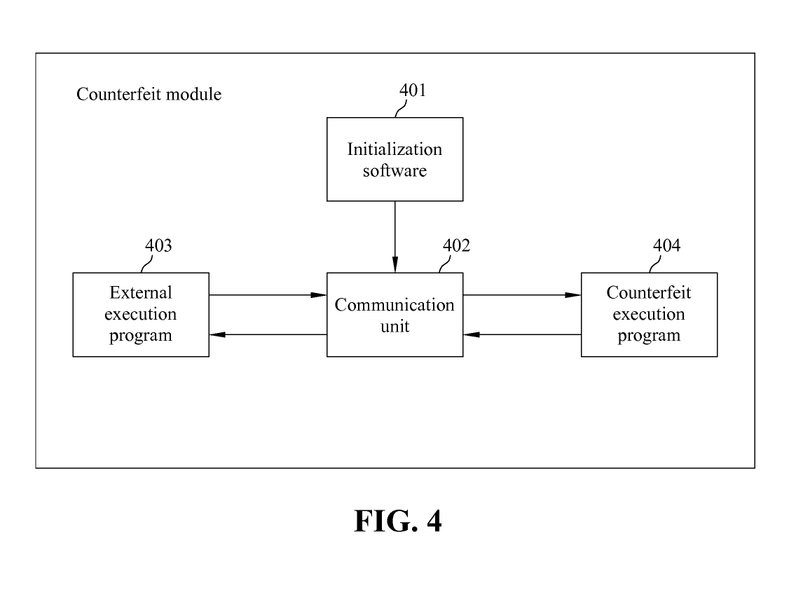

FIG. 4 shows a block diagram representing the counterfeit control module 40 employed in the banknote counting and authenticating machine of the present invention. As illustrated, the counterfeit module 40 includes an execution program 401, upon power supplied to the machine owing to switch-on action of the machine, for conducting an execution operation including initialization of basic settings, self checking, checking communication among modules, idling or suspending signal and abnormal signal; a communication unit 402 for establishing and checking communication between the counterfeit control module 40 and an external component via the user interface, and turning into an idle mode after completion of the execution operation; an external execution program 403 adapted to be coupled with a PC in order to use execution program of the PC, thereby simultaneously updating the external execution program to fetch and/or store data in the PC and realizing the authentication process of the banknote; and a counterfeit execution program 404 upon receipt of the banknote input signal for conducting the authentication process of the banknote and transmitting the banknote result back to the electronic control module via the communication unit 402.

The above-mentioned external execution program 403 is enabled mainly to check the status quo of the counterfeit control module 40 and transmit function settings of each component to the PC, where the operator can manually handle the banknote or check malfunction of the machine. The re-setting parameters of the PC are updated in the counterfeit control module 40 such that the firmware can also be updated. Under this condition, the current data of the counterfeit control module are simultaneously displayed over the PC.

The counterfeit execution program 404 mainly includes a thickness detection program, a magnet detection program and an infrared detection program, wherein upon receipt of the banknote input signal from the electronic control module, conducts the banknote authentication process in the following manner.

The thickness detection program is capable of activating a thickness detector so as to determine if thickness of the banknote is normal or not. Note that prior to determining the thickness of the banknote, the thickness detection program is also capable of delaying fetching of data; activating the thickness detector only upon receipt of the banknote input signal from the electronic control module 10 so as to fetch data; fetching thickness data of the banknote and storing the thickness data within a cache; scanning the thickness of the banknote upon the thickness data reaching a first default value (such as one sheet of the banknote has a thickness of 70 mm, resolution 1 mm, +/−5 mm) and determining the thickness of the banknote is normal or not; de-activating the thickness detector when the thickness data reaching a second default value (such as 80 pieces of data); balancing left and right of the thickness detector and providing compensation temperature to the thickness detector; checking if corners of the banknote are folded; and transmitting a thickness result of the banknote back to the electronic control module 10.

The magnet detection program is capable of activating the reading head so as to fetch a magnetic signal from the banknote to determine the total amount of the banknote and detect if the banknote is forged. Note that prior to determining the total amount of the banknote, the magnet detection program is capable of delaying fetching of data; activating a reading head only upon receipt of the banknote input signal from the electronic control module 10 so as to fetch data; fetching magnetic data of the banknote and storing the magnetic data within a cache; authenticating the banknote quickly upon the magnetic data reaching a first default value (such as 20 pieces of data) to check if the banknote has magnetic reflection; de-activating the reading head when the magnetic data reaches a second default value (such as 80 pieces of data) to check if the banknote has magnetic reflection; checking if banknote surface of the banknote has magnetic response and analyzing whether magnetic regions and total amount of the banknote are compatible with those stored within a data base; and transmitting a magnetic result of the banknote back to the electronic control module 10.

The infrared detection program is capable of activating an infrared scanner so as to scan colors of the banknote in order to differentiate value amount of the banknotes based on the scanned colors. Note that prior to determining the total amount of the banknote, the infrared detection program is capable of delaying fetching of data; activating the infrared scanner only upon receipt of the banknote input signal from the electronic control module 10 so as to fetch data; fetching data of the banknote via infrared rays and storing the data within a cache; authenticating the banknote quickly upon the data reaching a first default value so as to check colors of the banknote; de-activating the infrared scanner when the data reaches a second default value; correcting and providing compensation data to the infrared scanner; checking if colors of the banknote are compatible with those stored within a data base; and transmitting an infrared result back to the electronic control module 10.

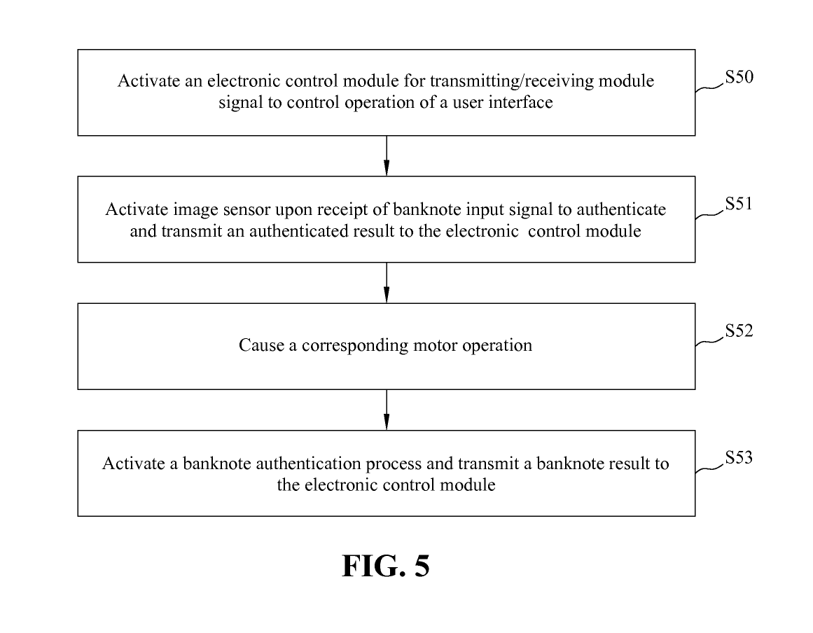

FIG. 5 illustrates steps constituting a method for counting and authenticating a banknote according to the present invention. As illustrated, the method for counting and authenticating a banknote of the present invention includes step (S50), in which the electronic control module is activated for controlling a banknote counting and authentication machine and for transmitting/receiving every module signal to control operation of the user interface and then enters into step (S51).

In step (S51), the image sensor is activated upon receipt of a banknote input signal from the electronic control module so as to read and authenticate the banknote, thereby resulting in an authenticated result and transmitting the same back to the electronic control module 10.

In step (S52), causing a corresponding motor operation of a motor in the machine upon receipt of the banknote input signal from the electronic control module 10 and then enters into step (S53).

In step (S53), a banknote authentication process is activated via the reading head, the thickness detector and the infrared scanner upon receipt of another signal from the electronic control module 10 and the banknote result caused thereby is transmitted back to the electronic control module 10 for further execution.

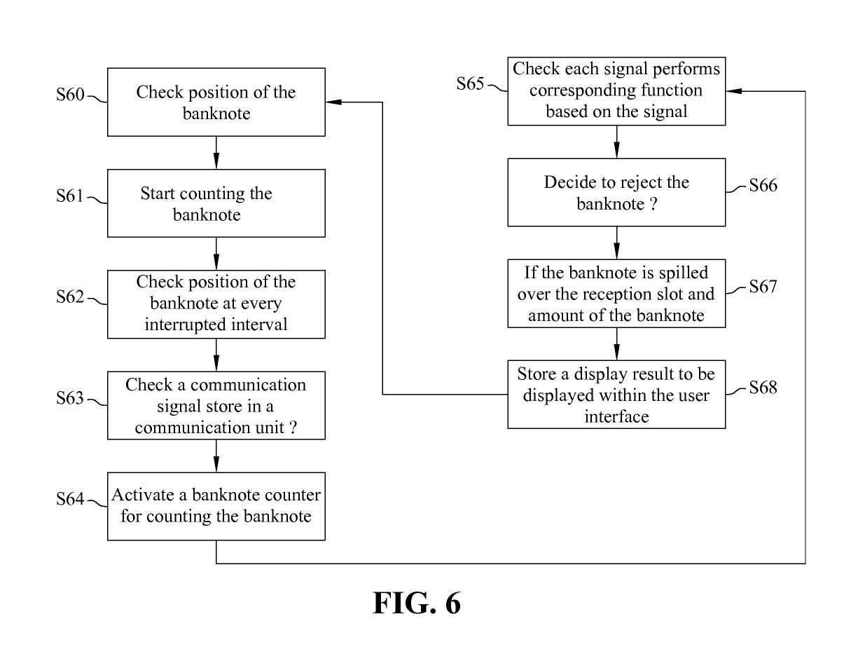

FIG. 6 illustrates steps of conducting the authentication process of the banknote according to the present invention. The authentication process of the banknote includes step (S60); waiting till finishing of disposal of the banknote in the banknote reception slot and checking position of the banknote in the banknote reception slot prior to start counting the banknote. When the machine enters into the counting mode from the suspending mode, some functions are not activated while the other functions are activated such that the touch panel will display malfunction signal via the timer ISR when the banknote is not counted.

In step (S61): start counting the banknote and transmitting an inform signal to the motor control module to simultaneously activate timer ISR. During counting, the following functions are performed: (1) upon entering into the counting mode from the suspending mode, activating the motor control module via the GPIO; (2) transmitting a signal so as to deactivate and stop the motor in emergency situation; (3) returning the motor to its initial speed after the emergency situation via the GPIO; (4) resuming the motor to run in an idling state or stopping the same in case of the suspending mode; and (5) no signal is transmitted when no malfunction is shown.

In step (S62): after counting of the banknote, the authentication process further includes checking position of the banknote at every interrupted interval caused by timer ISR and recording the banknote position data.

In step (S63): check based on the banknote position data if a communication signal to be sent is stored in a communication unit and transmit an interruption signal via a software to interrupt counting of the banknote.

In step (S64): based on the banknote position data, activate a banknote counter in the machine for counting the banknote.

In step (S65): check using the signal transmission unit each communication signal stored in the communication unit and whether each signal performs corresponding function based on the signal.

In step (S66): decide whether to reject the banknote or not based on the banknote position data and depending on an executed result generated from the banknote counter.

In step (S67): determine if the banknote is spilled over the banknote reception slot and the amount and number of the banknote.

In step (S68): store a display result to be displayed over a display screen within the user interface and transmit a software interruption signal to stop the operation of the machine.

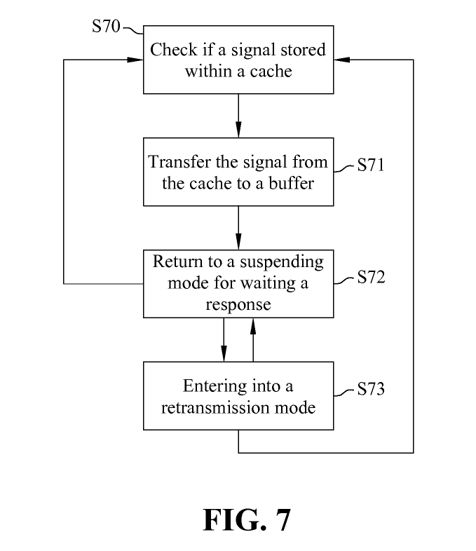

FIG. 7 illustrates the step (S70) of transmitting/receiving the module signal among modules employed in the banknote counting and authenticating machine of the present invention. The step (S70) includes check if a signal being stored within a cache upon receipt of the interruption signal and then enters into step (S71).

In step (S71): if the signal is stored with the cache, transfer the signal from the cache to a corresponding buffer for automatically transmitting the signal. Note the signal transferring is conducted via the UART of the image control module 20 and the SPI of the counterfeit control module.

In step (S72): return to a suspending mode for waiting a response due to transmission of the signal, turning to a next step if the transmission of the signal is incorrect or delete the signal from the buffer if the transmission of the signal is correct and transmitting a software interruption signal and deleting a response flag.

In step (S73): entering into a retransmission mode for checking if the output hardware functions normally or not and else retransmitting the software interruption signal again.

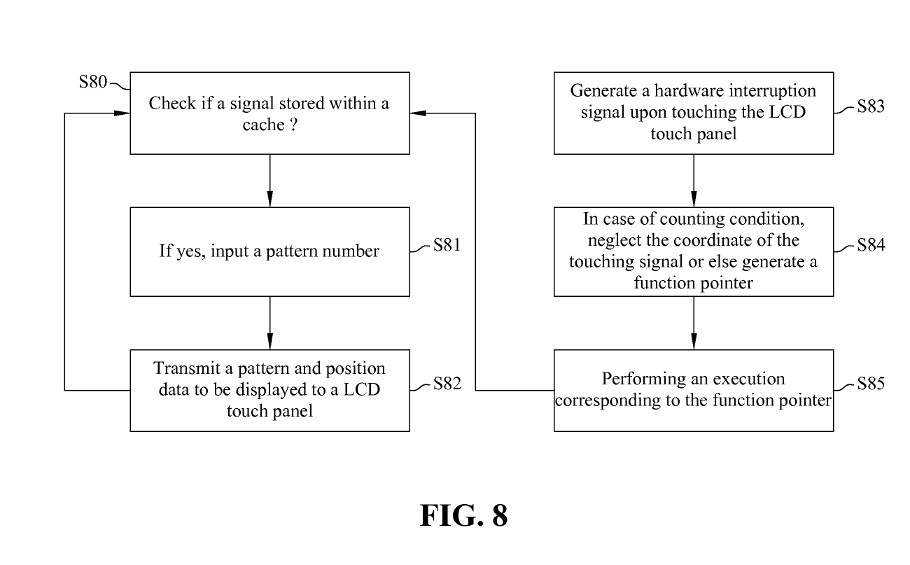

FIG. 8 illustrates steps of controlling operation for the user interface employed in the banknote counting and authenticating machine of the present invention. As shown, the control operation of the user interface includes step (S80), checking if a signal is stored within a cache.

In step (S81): if yes, input a pattern number corresponding to array position of code mark representing the signal.

In step (S82): transmit a pattern and position data to be displayed to a display panel.

In step (S83): generate a hardware interruption signal upon touching the display panel of display device and transmit a coordinate of the touching signal.

In step (S84): in case of counting condition, neglect the coordinate of the touching signal and generate a function pointer corresponding to the coordinate of the touching signal in case of non-counting condition.

In step (S85): perform an execution or task corresponding to the function pointer and transmit a software interruption signal upon completion of the task to repeat steps (S80)-(S82) or else terminate the machine.

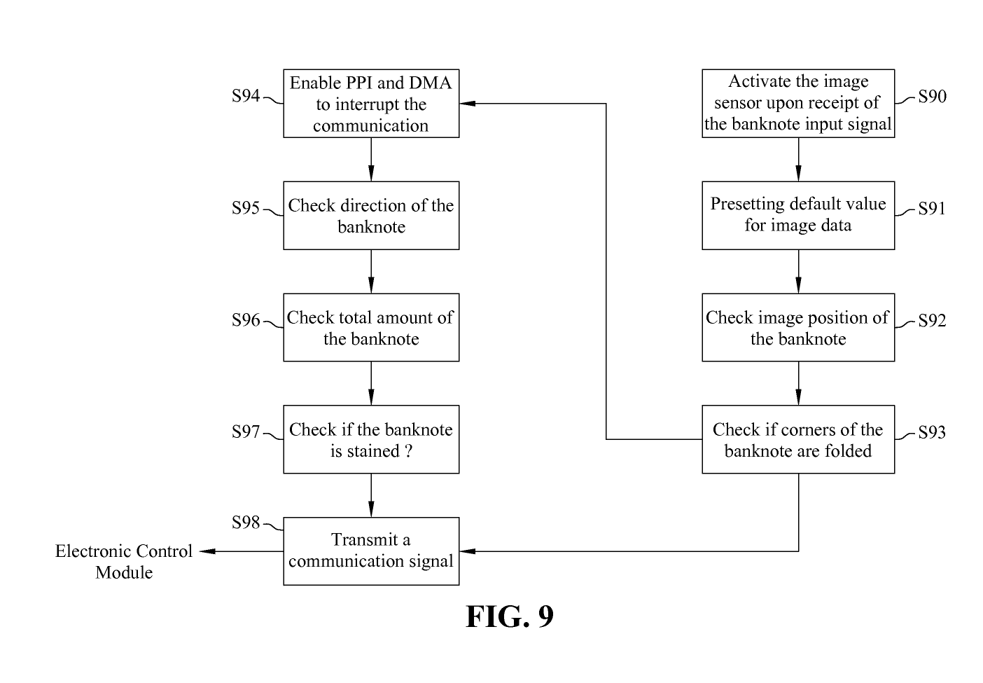

FIG. 9 illustrates the banknote authentication process of the banknote via the image sensor of the present invention includes step (S90), in which the image sensor is activated upon receipt of the banknote input signal so as to scan the banknote via the CPLD, thereby generating the image data and converting the image data into a two dimensional signal.

In step (S91): conduct the authentication process of the banknote via the DMA when the image data reaches a default value. Prior to the authentication process, the default value is defined initially by a digital signal processor (such as BF533), connecting the PPI and DMA in series, presetting no of pieces as 2304×520. In other words, upon receiving data consisting 2304 pixels×520 lines in DMA via the PPI and the CPLD results in an interruption of communication between the PPI and the DMA.

In step (S92): check image position of the banknote, where two pixel filters (5×2) (2×5) are used to locate the periphery of the banknote in the horizontal and vertical directions since one side of the banknote requires at least two points. Eight points are thus obtained via the filters to form a first image section, hence defining two left peripheral points, a second image section having four upper and lower peripheral points. A third image section with two right peripheral points is defined by eight peripheral points, hence obtaining four tips of the banknote. If no checking image position of the banknote is conducted, the RS-232 is used to inform “no authentication” to the electronic control module 10.

In step (S93): checking if corners of the banknote includes two dimensional imaging process is used for determine if corners of the banknote are folded and the RS-232 is used to inform “folded signal” to the electronic control module 10.

In step (S94): the communication between the PPI and DMA is interrupted and is again enabled to perform the other authentication action, such as receiving the image data.

In step (S95): check direction of the banknote includes fetching image at left/right top and bottom corners, at ¼ or 9/10 of the banknote by applying characteristic to define the direction (upper/upper upper/lower direction) and the result is transmitted to the electronic control module 10 via the RS-232.

In step (S96): checking total amount of the banknote includes top point parameters and the length and width of the banknote are used to determine the total amount (100$, 200$, . . . , 200$), and the amount result is transmitted to the electronic control module 10 via the RS-232.

In step (S97): checking if the banknote is stained includes utilizing average value of image is used to determine whether the banknote is stained or not.

In step (S98): the result is transmitted back to the electronic control module 10 via the RS-232.

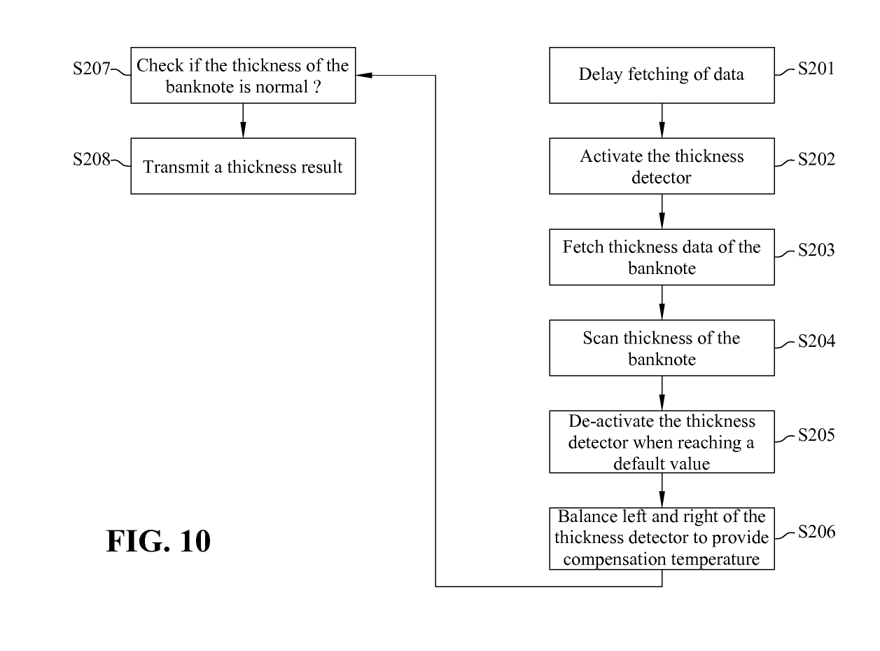

FIG. 10 illustrates some steps for detecting thickness of the banknote of the present invention, such as activating the thickness detector to as to check if thickness of the banknote is normal or not via the following steps. In step (S201): delay fetching of thickness data prior to activating the thickness detector.

In step (S202): activate the thickness detector so as to fetch the thickness data.

In step (S203): fetch the thickness data of the banknote and store the thickness data within a cache.

In step (S204): scan the thickness of the banknote and upon the scanned thickness reaching a first default value, such as 80 pieces of data (like one sheet of banknote has 70 mm thickness, resolution 1 mm, +/−5 mm) and a simple authentication is conducted to determine if the thickness of the banknote is normal or not.

In step (S205): de-activate the thickness detector when the thickness data reaching a second default value (such as 80 pieces of data).

In step (S206): balance left and right of the thickness detector to provide compensation temperature to the thickness detector.

In step (S207): check if corners of the banknote are folded, if the banknote is stained or not or if the thickness of the banknote is normal.

In step (S208): transmit a thickness result of the banknote back to the electronic control module.

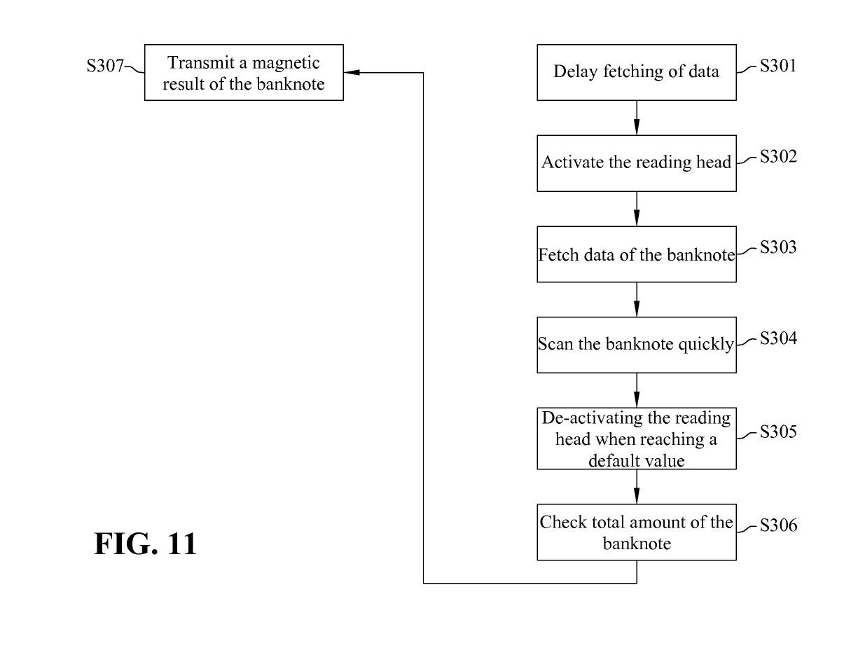

FIG. 11 illustrates some steps for determining total amount of the banknote via magnet detection program in the present invention. The magnet detection program is capable of activating a reading head so as to fetch a magnetic signal from the banknote to determine the total amount of the banknote and detect if the banknote is forged. To be more specific, the detecting steps include (S301): delay fetching of the magnet data prior to activating the reading head.

In step (S302): activate the reading head in order to read the banknote.

In step (S303): fetch the magnetic data of the banknote and store the same within a cache.

In step (S304): upon the magnetic data reaching a first default value (such as 20 pieces of data), the thickness of the banknote is scanned quickly.

In step (S305): de-activating the reading head when the magnetic data reaches a second default value (such as 80 pieces of data).

In step (S306): check if banknote surface of the banknote has magnetic response and analyzing whether magnetic regions and total amount of the banknote are compatible with those stored within a data base.

In step (S307): transmit a magnetic result of the banknote back to the electronic control module.

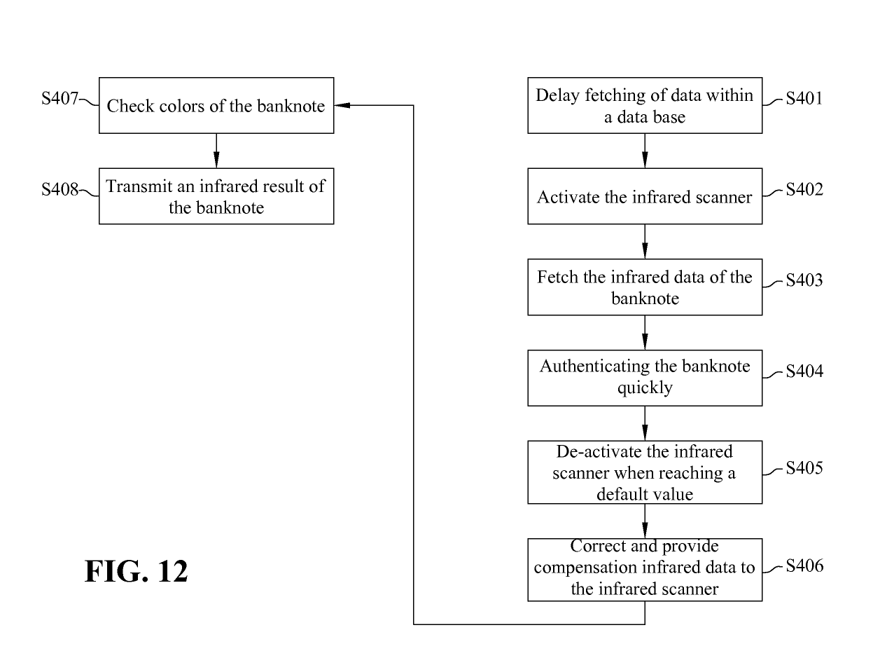

FIG. 12 illustrates some steps for authenticating images in the banknote via an infrared detection program in the present invention. The infrared detection program is capable of activating the infrared scanner so as to scan colors of the banknote via infrared rays so as to differentiate value amount of the banknotes based on the scanned colors. To be more specific, in step (S401): delay fetching of image data prior to activating the infrared scanner.

In step (S402): activate the infrared scanner.

In step (S403): fetch the data of the banknote via infrared rays and store the same within a cache.

In step (S404): authenticating the banknote quickly upon the data reach a first default value (such as 20 pieces of data) so as to check colors of the banknote.

In step (S405): de-activate the infrared scanner when the data reach a second default value (such as 80 pieces of data).

In step (S406): correct and provide compensation data to the infrared scanner.

In step (S407): check if colors of the banknote are compatible with those stored within a data base.

In step (S408): transmit an infrared result of the banknote back to the electronic control module.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A machine for counting and authenticating a banknote, comprising:
an electronic control module for conducting authentication process of the banknote and transiting/receiving every module signal to control operation of a user interface;
an image control module for activating an image sensor to read and authenticate the banknote upon receipt of a banknote input signal from said electronic control module, thereby resulting in an authenticated result and transmitting back to said electronic control module;
a motor control module for causing a corresponding motor operation of a motor upon receipt of a command signal from said electronic control module; and
a counterfeit control module for processing a banknote data via a reading head, a thickness detector and an infrared scanner upon receipt of another signal from said electronic control module and generating, transmitting a banknote result back to said electronic control module for further processing.

2. The machine according to claim 1, wherein said electronic control module further includes:
an initialization unit for initializing operation systems and execution programs of each of said modules when switch-on action of the machine and upon finishing initialization of each of said modules displaying said operation systems and said execution programs in ready position or a malfunction signal;
a counterfeit unit for authenticating the banknote including detecting and processing the banknote, thereby resulting in said banknote result;
a signal transmission unit for transmitting and receiving signal among said modules; and
a user interface unit for displaying said banknote result which is generated from said counterfeit unit and which is shown on a display panel.

3. The machine according to claim 2, wherein said image control module further includes:
an image fetching unit for activating said image sensor upon receipt of said banknote input signal so as to scan the banknote via a built-in CPLD, thereby generating an image data and converting said image data into a two dimensional signal; and
an image verifying unit for receiving said image data from said image fetching unit via PPI and conducting the authentication process of the banknote via DMA when said image data reaches a default value.

4. The machine according to claim 1, wherein said corresponding motor operation caused by said motor control module includes:
activating the motor;
de-activating the motor;
stopping the motor in emergency situation;
returning the motor to its initial speed; and
resume the motor to run in an idling state.

5. The machine according to claim 1, wherein said counterfeit module includes:
an execution program, upon power supplied to the machine owing to switch-on action of the machine, for conducting an execution operation including initialization of basic settings, self checking, checking communication among modules, idling or suspending signal and abnormal signal;
a communication unit for establishing and checking communication between said counterfeit control module and an external component via said user interface, and turning into an idle state after completion of the execution operation;
an external execution program adapted to be coupled with a PC in order to use execution program of the PC, thereby simultaneously updating said external execution program to fetch and/or store data in the PC and realizing the authentication process of the banknote; and
a counterfeit execution program upon receipt of the banknote input signal for conducting the authentication process of the banknote and transmitting the banknote result back to said electronic control module via said communication unit.

6. The machine according to claim 5, wherein said authentication process of the banknote includes a thickness detection program, a magnet detection program, and an infrared detection program.

7. The machine according to claim 6, wherein said thickness detection program is capable of activating said thickness detector so as to determine if thickness of the banknote is normal or not.

8. The machine according to claim 6, wherein said magnet detection program is capable of activating said reading head so as to fetch a magnetic signal from the banknote to determine the total amount of the banknote and detect if the banknote is forged.

9. The machine according to claim 6, wherein said infrared detection program is capable of activating said infrared scanner so as to scan colors of the banknote so as to differentiate value amount of the banknotes based on the scanned colors.

10. A method for counting and authenticating a banknote, comprising the steps of:
activating an electronic control module for controlling a banknote counting and authenticating machine and transiting/receiving every module signal to control operation of a user interface of a machine;
receiving a banknote input signal from said electronic control module to activate an image sensor to read and authenticate the banknote, thereby resulting in an authenticated result and transmitting back to said electronic control module;
causing a corresponding motor operation of a motor in the machine upon receipt of another signal from said electronic control module; and
activating a banknote authentication process of the banknote via a reading head, a thickness detector and an infrared scanner upon receipt of another command signal from said electronic control module and generating, transmitting a banknote result back to said electronic control module for further processing.

11. The method according to claim 10, wherein said authentication process of the banknote includes:
waiting till finishing of disposal of the banknote in a banknote reception slot and checking position of the banknote in the banknote reception slot prior to counting operation begin;
start counting the banknote and transmitting an inform signal to a motor control module to simultaneously activate a timer Interrupt Service routine (ISR);
said image sensor scanning the banknote at each interruption interval caused by the timer ISR so as to check position of the banknote, thereby recording banknote position data;
based on the banknote position data, a communication signal to be sent being stored in a communication unit and transmitting an interruption signal to interrupt counting of the banknote;
based on the banknote position data, activating a banknote counter in the machine for counting the banknote;
a signal transmission unit checking if the communication signal performs corresponding function based on the banknote signal;
deciding, based on the banknote position data and depending on an executed result generated from the banknote counter, whether to reject the banknote or not;
determining sheet amount of the banknote and if the banknote is spilled over the banknote reception slot; and
storing a display result within the user interface to be displayed over a display screen.

12. The method according to claim 10, wherein said transiting/receiving every module signal step includes:
checking if a signal being stored within a cache;
if yes, transferring the signal from the cache to a corresponding buffer for automatically transmitting said signal;
returning to a suspending mode for waiting a response due to transmission of said signal, turning to a next step if the transmission of said signal incorrect, delete said signal from the buffer if the transmission of said signal is correct and transmitting a software interruption signal and deleting a response flag; and
entering into a retransmission mode for checking an output hardware function normally or not and retransmitting said software interruption signal again.

13. The method according to claim 10, wherein said control operation of the user interface includes the steps of:
(a) checking if a signal being stored within a cache;
(b) if yes, inputting pattern number corresponding to array position of code mark representing said signal;
(c) transmitting a pattern and position data to be displayed to a display panel;
(d) generating a hardware interruption signal upon touching the display panel of display device and transmitting a coordinate of the touching signal;
(e) neglecting the coordinate of the touching signal in case of counting condition, and generating a function pointer corresponding to the coordinate of the touching signal in case of non-counting condition; and
(f) performing a task corresponding to the function pointer and transmitting a software interruption signal upon completion of the task to repeat steps (a)-(c) or else finishing.

14. The method according to claim 10, wherein said banknote authentication process of the banknote via the image sensor includes the steps of:
activating the image sensor upon receipt of said banknote input signal so as to scan the banknote via a built-in CPLD, thereby generating an image data and converting said image data into a two dimensional signal; and
conducting the authentication process of the banknote via DMA when said image data reaches a default value after receiving said image data via PPI.

15. The method according to claim 14, wherein said banknote authentication process of the banknote further includes the steps of:
checking position of the banknote;
checking if corners of the banknote are folded;
checking direction of the banknote;
reading the image data so as to obtain width and length of the banknote to determine total amount of the banknote;
determining if the banknote is stained based on average value of the image data; and
transmitting the authenticated result back to said electronic control module.

16. The method according to claim 10, wherein said banknote authentication process includes the steps of:
receiving a signal from the electronic control module;
entering into an authentication mode;
detecting a thickness of the banknote via a thickness detection program, via a magnet detection program and via an infrared detection program; and
transmitting the authenticated result back to said electronic control module.

17. The method according to claim 16, wherein said thickness detection program includes:
delaying fetching of data;
activating a thickness detector so as to fetch data;
fetching thickness data of the banknote and storing said thickness data within a cache;
scanning a thickness of the banknote upon said thickness data reaching a first default value and determining the thickness of the banknote is normal or not;
de-activating said thickness detector when said thickness data reaching a second default value;
balancing left and right of said thickness detector and providing compensation temperature to said thickness detector;
checking if corners of the banknote are folded; and
transmitting a thickness result of the banknote back to said electronic control module.

18. The method according to claim 16, wherein said magnet detection program includes:
delaying fetching of data;
activating a reading head so as to fetch data;
fetching magnetic data of the banknote and storing said magnetic data within a cache;
authenticating the banknote quickly upon said magnetic data reaching a first default value;
de-activating said reading head when said magnetic data reaches a second default value;
checking if banknote surface of the banknote has magnetic response and analyzing whether magnetic regions and total amount of the banknote are compatible with those stored within a data base; and
transmitting a magnetic result of the banknote back to said electronic control module.

19. The method according to claim 16, wherein said infrared detection program includes:
delaying fetching of data;
activating an infrared scanner so as to fetch data;
fetching data of the banknote via infrared rays and storing said data within a cache;
authenticating the banknote quickly upon said data reaching a first default value so as to check colors of the banknote;
de-activating said infrared scanner when said data reaches a second default value;
correcting and providing compensation data to said infrared scanner;
checking if colors of the banknote are compatible with those stored within a data base; and
transmitting an infrared result of the banknote back to said electronic control module.
